(19) United States
(12) Patent Application Publication
(10) Pub. No.: US 2003/0225617 A1
(43) Pub. Date: Dec. 4, 2003

(54) Point pass-on system

(76) Inventor: Tokihiro Sumiyoshi, Aichi Prefecture (JP)

Correspondence Address: JENNER & BLOCK, LLC, ONE IBM PLAZA, CHICAGO, IL, 60611, US

(21) Appl. No.: 10/255,330

(22) Filed: Sep. 26, 2002

Related U.S. Application Data
(63) Continuation-in-part of application No. 10/162,024, filed on Jun. 4, 2002.

(51) Int. Cl. G06F 17/60

(52) U.S. Cl. 705/14

(57) ABSTRACT

A point pass-on system is provided which permits users to utilize points without restrictions on use units and purposes and increase a point recovery rate. The amount of points held by a user is converted to reference points based on a conversion rate. Upon collecting a participation fee from each user by the user held points, the content providing unit provides the user with contents such as a game, auction, survey, contest and the like. A point management unit manages the participation fee and the balance of bet as well when the content is accompanied by a bet, and accumulates the consumed points for each partner organization and reports the accumulated consumption value for each organization thereto.

### BACKGROUND OF THE INVENTION

1. Field of the Invention

The present invention relates to a point pass-on (or redemption) system, and more particularly, to a point pass-on system for effectively utilizing and redeeming points issued by virtual organizations such as virtual shops on a network such as the Internet, and real organizations such as real shops like department stores.

2. Description of the Prior Art:

The number of customers visiting web pages which are provided by web sites such as electronic commerce sites, game providing sites, music delivery sites and the like on the Internet, i.e., virtual shops, directly relates to the valuation and revenue of the virtual shops. It is, therefore, an object of shop managers to increase the number of customers visiting their virtual shops. As a means of increasing customers to a virtual shop, electronic points are issued associated with a visit of a user to the virtual shop and a transaction with the shop. The user who has accumulated a predetermined amount or more of the electronic points can receive service benefits or privileges provided by the associated virtual shop. There are a variety of service benefits, one of which permits the user to use the electronic points just like cash.

However, since a user receives a relatively low amount or value of electronic points from a virtual shop per electronic trade or the like, the user is forced to spend a considerable amount of time and effort to accumulate a sufficient number of electronic points to receive a preferred service benefit. This is partially because different electronic points are utilized in different virtual shops in principle, and partially because their period of validity is relatively short.

For reasons set forth above, at present, the amount of electronic points utilized by users (the amount of benefit provided for users) is extremely low with respect to the amount of issued electronic points. Therefore, the utilization efficiency of the electronic points is too low to provide sufficient benefits to users, which is the essential object of issuing the electronic points.

Also, the fact that a long period is required to accumulate a sufficient number of electronic coupons or points to receive a service benefit, means that there are a huge number of electronic points remaining on the network which can be requested for passing them on in the future. Therefore, a virtual shop, which issues the electronic points, must prepare, at all times, service benefits commensurate with the electronic points issued by itself and remaining on the network so that the virtual shop can promptly pass the electronic points onto a consumer who requests a service benefit. This causes a burden on the virtual shop's manager.

The foregoing problem is true for points issued by real shops such as real department stores, amusement centers or the like as well as for points issued by virtual shops.

### SUMMARY OF THE INVENTION

The present invention has been made in view of the problem inherent to the prior art as mentioned above, and it is an object of the invention to facilitate the distribution of points issued by point issuing organizations such as virtual shops, real shops and the like substantially without restriction on use units and purposes, thereby improving the point utilization efficiency and pass-on rate.

To achieve the above object, the present invention provides a point pass-on system running in computer software for restoring points issued by virtual and/or real partner organizations. The system according to the present invention comprises:

means for calculating a conversion rate for converting points issued by each of the partner organizations to a reference point value;

means for storing the conversion rates correspondingly to the respective partner organizations;

means for communicating with the partner organizations and obtaining the amounts of points issued thereby and held by users;

point management means for converting the amount of points issued by each partner organization and held by each user who wishes to access a content, to the amount of reference points with reference to the conversion rate associated with the partner organization;

means for storing the converted reference point amount correspondingly to each user and each organization;

means for collecting a participation fee from the user held points, and providing the user with a content; and

means for reporting to each partner organization, the amount of accumulated consumption points associated therewith at a predetermined time interval, the amount of the accumulated consumption points being stored in the point storing means,

the point management means further accumulating the points for each partner organization, corresponding to the collected participation fees and storing the amount of the accumulated points as the amount of the accumulated consumption points in the point storing means.

In the system according to the present invention, it is preferable that the content providing means be adapted to provide content including a game in which a user can participate only when the user pays a bet with points, and the point management means is further adapted to accumulate the bets as consumption points for the associated organizations when no winner is determined in execution of the game in addition to the accumulated amount of consumption points of the participation fees collected from the users.

In an embodiment of the system according to the present invention, the conversion rate calculating means is adapted to calculate the new conversion rates on the basis of the following equation:

xi(j+1)=log m(xi(j)*Xi(j))/Σ log m(xk(j)*Xk(j))

In the above equation, x1(j), x2(j), . . . ,xi(j), . . . ,xn(j) denote current conversion rates for the respective organizations during the current time period T(j), x1(j+1), x2(j+1), . . . ,xi(j+1), . . . ,xn(j+1) denote new conversion rates for the respective organizations during the next time period T(j+1), and X1(j), X2(j), . . . , Xi(j), . . . , Xn(j) denote recovered points for the respective organizations during the current time period T(j), and xi(j)*Xi(j)>1.

In the above embodiment, it is preferable that the conversion rate calculating means is further adapted to change the base m of the logarithmic function to a larger value when at least one of the calculated new conversion rates is predetermined as large as an average value thereof, and then repeat the above equation.

Further, in the system according to the present invention, it is preferable that the content providing means further comprises means for providing a content selection page on which a user can select one of the offered content, the page containing predetermined reference point value corresponding to the participation fee for each content, and further containing point values issued by the partner organizations and corresponding to the reference point value for each content.

In addition, it is preferable that the system according to the present invention further comprises means for registering users as members, and wherein the content providing means is adapted to provide only the members with the content.

### BRIEF DESCRIPTION OF THE DRAWINGS

FIG. 1 is a block diagram generally illustrating a point pass-on system on a network such as the Internet, according to the present invention.

FIG. 2 shows a graph for explaining a calculation of point conversion rate in the point pass-on system according to the present invention; and

FIG. 3 is a flow chart for explaining the operation of the point pass-on system according to the present invention.

### DETAILED DESCRIPTION OF THE EMBODIMENT

First, the description begins with the concept of a point pass-on system according to the present invention. The system of the present invention is built as a website on a network such as the Internet and makes a partner contract, on a one-to-one basis, with partner point issuing organizations such as virtual shops, real shops and the like which issue their own points. The system evaluates the points issued by the partner organizations or shops, and determines a conversion rate of the points to reference points for each organization. The system also registers users as members or affiliates who hold the points issued by the partner organizations, and makes good use of the nature of the virtual space on the network. Namely, the system provides, at an actually unavailable speed, content such as contests, games, surveys, auctions or the like in which a large number of users can simultaneously participate. The system collects points as participation fees from users who participate in such content. In this way, a large amount of points can be collected in a short time in the form of participation fees, because a large number of point holders can simultaneously participate in quick games and so on.

For providing game content, the system collects the points from participants as bets, and gives all the bets as reference points to a winner of the game. When there is no winner, the system can recover the points associated with the bets. Recovered points can be regarded as spent, i.e., consumed.

With the point pass-on system, a user can enjoy a variety of content using a small amount of points, which would normally be left unused. Also, since a user can acquire a large amount of points when he or she wins a game or the like, the user may obtain a sufficient point value and therefore can exchange the obtained points for a service benefit. On the other hand, a virtual shop, a real shop or the like, which issues the points, can newly issue points corresponding to the consumption value without providing new funds.

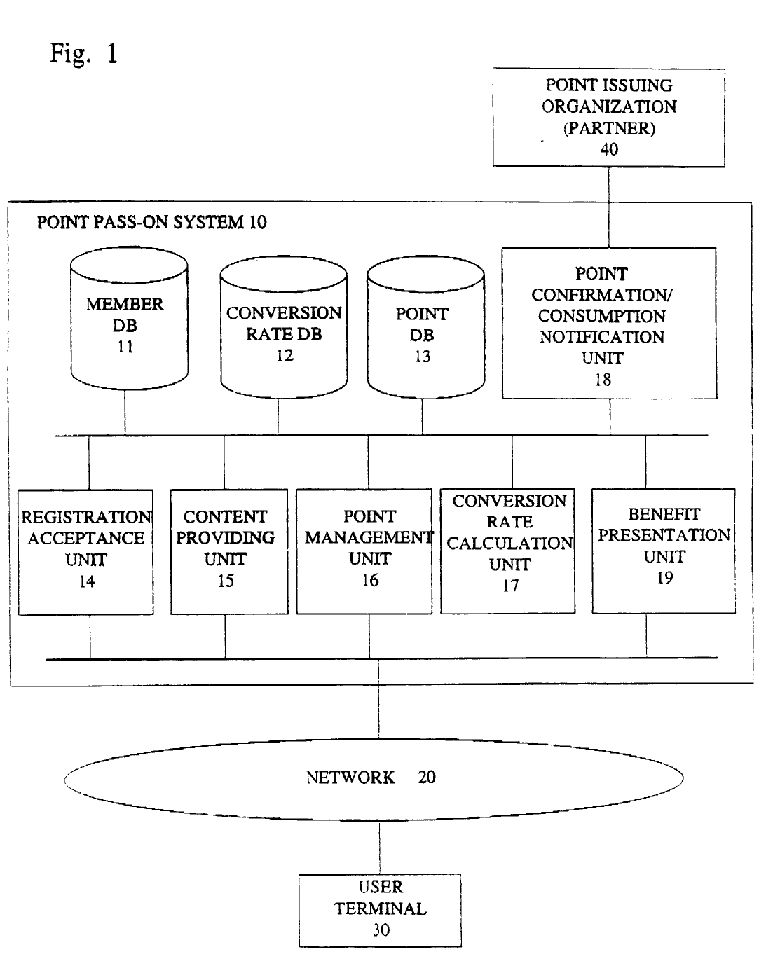

FIG. 1 illustrates a general block diagram including a point pass-on system according to the present invention. In FIG. 1, the network includes the point pass-on system 10 according to the present invention; a network 20 such as the Internet; a user (member) terminal 30; a point issuing organization or a partner organization 40. Since only one user terminal 30 and only one partner organization 40 are illustrated in FIG. 1, it is a matter of course that many user terminals and a plurality of partner point issuing organizations are connectable to the point pass-on system. The partner organizations 40 are real shops and virtual shops on the network, which provide users with points. The partner organization 40 has a communication terminal (not shown) connectable to the point pass-on system 10 through a dedicated line. It may be connected thereto through the network 20.

The point pass-on system 10 comprises a member database (DB) 11, a conversion rate database 12 and a point database 13. The system 10 also comprises a registration acceptance unit 14 for accepting member registration from the user terminals 30; a content providing unit 15 for providing members with content such as games, auctions, surveys, contests or the like on web pages; a point management unit 16 for managing the points for each member 30 and each partner organization 40; and a conversion rate calculation unit 17 for calculating a conversion rate of points associated with each partner organization 40 at a predetermined interval. Further, the system 10 comprises a point confirmation/consumption notification unit 18 for communicating with each partner organization 40 to confirm points issued thereby and for reporting amounts of recovered or consumed points relating to the organization; and a benefit presentation unit 19 for presenting benefits to members.

In the point pass-on system 10, when a user accesses the home page of the system 10 and registers as a member on a page provided by the registration acceptance unit 14, user information, including the user's name and identification number of the user (user ID and/or password), a name of the partner organization the user has point with and the amount of points held by the user, is stored in the member database 11.

The conversion rate database 12 stores conversion rates obtained by the conversion rate calculation unit 17, which are used to convert points issued by the partner organizations to reference points, respectively.

The point confirmation/consumption notification unit 18 communicates with the partner organizations 40 the name of the registered user to obtain information of the amount of points held by the user. The amount of points is stored as the member held point amount with tags representative of the associated user and partner organization, in the point database.

The amount of reference points converted from the member held point amount by the point management unit 16 is also correspondingly stored in the point database 13. The point management unit 16 converts the member held point amount for each partner organization 40 to the reference point amount by using the associated conversion rate stored in the conversion rate database 12. Further, the accumulated amount of points consumed by the user is stored in the point database 13, as the amount of accumulated member consumption points with the tags representative of the associated user and partner organization. The member consumption points are accumulated by the point management unit 16.

When registered as a member, the user can access web pages provided by the content providing unit 15 of the point pass-on system 10 from the user terminal 30, and can therefore enjoy content by paying a predetermined number of points set as a participation fee for each content.

Following is a description of a “sandwich game” which is one example of a game provided by the content providing unit 15. This is a card game which is played between a dealer of the content providing unit 15 and a member, i.e., a player. Since this is not a competition game between players, the game does not require a regular connection of a communication line and is not affected by the action of other players. Therefore, any number of players can simultaneously participate in the game, and individual users can adjust the frequency at which he participates in the game.

The sandwich game prescribes the following rules.

A player pays a participation fee (for example, ten reference points) each time the player participates in the game.

When a player attempts to participate in the game, the player first selects a table through four parameters: “dealer name”, “game speed”, “limit of bet (for example, on the order of ten times the participation fee)” and “held point amount of table.”

Upon determination of a table, the player is automatically seated on any of a plurality of seats (for example, five seats A-E). At this time, the participation fee is automatically collected as well.

A dealer uses 40 cards from 1 to 10, and delivers two hand cards to the player.

The player has set the amount of points, which is a bet, until his turn comes around. For example, assuming that a player at seat C is about to draw the third card in his play when a certain player is automatically seated at seat B, the play continues in the order of players on seat D, seat E and seat A. The player at seat B must decide a bet, determined from the two hand cards, until his turn comes around. In this event, the amount-of the bet should be equal to or less than a limit set for each table. If no limit is set for a bet on a table, the bet is the amount of points held by the table or the amount of points (reference points) held by the player himself, whichever is the smaller.

If the third card delivered by the dealer has a value between the two hand cards, the player acquires the same amount as the bet points, and otherwise loses the bet points. The points the user has lost are accumulated as points held by the table.

As the points held by one table reaches a predetermined amount, the game on the table is over.

Assume, for example, such a game is played at a rate of once per second, the participation fee is ten reference points, 100 persons participate in the game on the average, and one person participates in the game every fifth game. In this event, approximately 17,000,000 reference points per day can be accumulated or consumed on the average. The amount of consumed points for each of the partner organizations 40 is accumulated for a predetermined time period and the accumulated value is notified to the corresponding organization 40. The winner of the game can acquire points corresponding to the bet, and can pool the obtained points as a part of the held point amount. If the user desires, he or she can exchange the held points for an appropriate premium when the amount of the held reference points reaches a sufficient value.

The content providing unit 15 provides members with content such as auctions, surveys, contests and the like in addition to games. Content other than games will be described below in brief.

In an auction, a plurality of members pay a participation fee in the form of reference points to request participation in a bid for an article or a service, and as a result of the auction, a member who has made a successful bid pays the reference points corresponding to the highest bid. The reference points corresponding to the highest bid are passed onto the person who offered the article.

In a survey, a plurality of members can state opinions. A member can state an opinion by paying a participation fee with the reference points. No consideration is offered to a member who has stated an opinion.

In a contest, a plurality of members compete for a particular target, and the contest is terminated at the time a member reaches the target, or several members survive even if no member reaches the target. Participants in the contest also pay a participation fee by reference points. A winner of the contest is provided with a benefit from the benefit presentation unit 17. The benefit is a preset amount of reference points.

The content provision unit 15 provides a content selection page on which a user can select content, such as a game, auction, survey and contest as described above. The page contains, for each content thereon, a summary of the content, the amount of reference points as a participation value and the amount of points for the respective partner organizations 40 corresponding to the participation value. As to the participation point amounts respectively associated with the partner organizations 40, the content selection page may show the amounts associated with only the user declared organizations or all the organizations.

As the user selects the content and one of the partner organizations on the content selection page, and accepts the payment of the participation fee, the point management unit 16 updates data in the point database 13 by subtracting the amounts of points (associated with the selected organization) and reference points corresponding to the fee from the member held points (associated with the selected organization) and member held reference points in the point database 13. The unit 16 further adds the participation fee or points to an accumulated consumption points associated with the user and the selected organization in the point database 13, to update the accumulated consumption value.

Through the point management unit 17, the accumulated consumption points associated with a member and a partner organization from the point database 13 at a predetermined time interval are read out, and the point confirmation/consumption notification unit 18 informs the associated organization of the amount of the points. Accordingly, each partner organization 40 can know the amount of the consumed points for each user who has obtained points issued by the organization, and thus can update the point information for the user in its own database.

The conversion rates in the database 12 are sent through unit 18 to the respective partner organization correspondingly, under the control of the point management unit 16.

Even after the member registration, when a user newly acquires points from any of the partner organization(s) 40 or loses his or her own points, such changes are reported from the organization 40 to the point management unit 16 through the point confirmation/consumption notification unit 18. Therefore, the held reference points and the held points associated with the member and organization in the point database 13 are automatically updated to coincide with his or her actual held points, under the control of the point management unit 16.

When each member has reference points equal to or larger than a certain predetermined value, the member can request a conversion of the held reference points to a service benefit on a page presented by the benefit presentation unit 19.

Next, the conversion rate calculation unit 17 will be explained. The unit 17 reads out the accumulated consumption points associated with each partner organization 40 from the point database 13 at a predetermined time interval, and calculates a new conversion rate on the basis of the accumulated consumption points and the current conversion rate for the organization 40. The resultant new conversion rates for all the organizations are then stored in the database 12, and are periodically updated.

It is assumed that there exists n partner organizations A1, A2, . . . ,Ai, . . . ,An, current conversion rates for the respective organizations during the current time period T(j) are denoted by x1(j), x2(j), . . . ,xi(j), . . . ,xn(j), new conversion rates for the respective organizations during the next time period T(j+1) are denoted by x1(j+1), x2(j+1), . . . ,xi(j+1), . . . ,xn(j+1), and recovered points for the respective organizations during the current time period T(j) are denoted by X1(j), X2(j), . . . , Xi(j), . . . , Xn(j).

The calculation unit 17 assigns the current conversion rates x1(j), x2(j), . . . ,xi(j), . . . ,xn(j) and the recovered points X1(j), X2(j), . . . , Xi(j), . . . , Xn(j) in the following Equation (1), in a case xi(j)*Xi(j)>1:

xi(j+1)=log m(xi(j)*Xi(j))/Σ log m(xk(j)*Xk(j)) (1)

In Equation (1), at the beginning of the calculation for obtaining xi(j+1), the base m is set to be equal to the finally adopted base value during the calculation of xi(j).

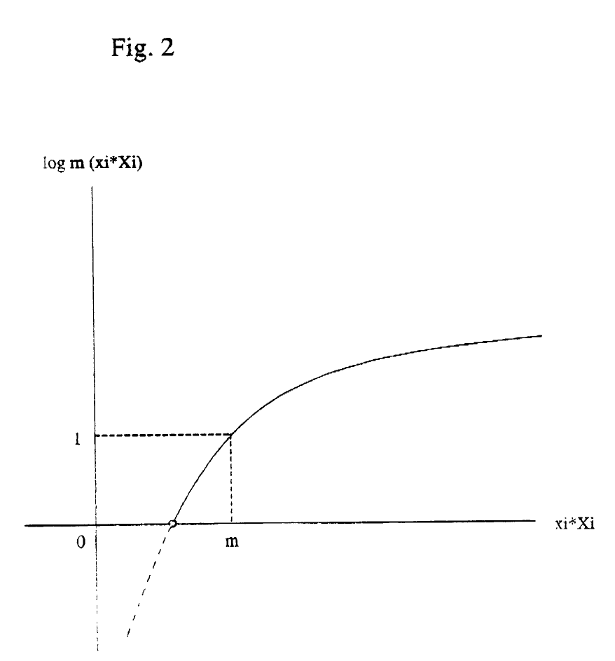

The relationship between (xi(j)*Xi(j)) and log m(xi(j)*Xi(j)) is represented by a graph as shown in FIG. 2. As is apparent from the graph, as (xi(j)*Xi(j)) is larger, Δ log m(xi(j)*Xi(j))/Δ(xi(j)*Xi(j)) becomes smaller. Therefore, even if (xi(j)*Xi(j)) is relatively large, the new conversion rate xi(j+1) calculated using Equation (1) may be relatively small, and hence all the new conversion rates may be included in a relatively small range.

However, if some of the new conversion rates are much larger (for instance, ten times larger) than the average value of all the new rates x1(j+1), x2(j+1), . . . ,xi(j+1), . . . ,xn(j+1), the base m of the logarithmic function is varied to be larger (for instance, several times larger) and a new set of conversion rates are calculated using Equation (1). By setting the base m to be larger, the graph shown in FIG. 2 moves toward the X-axis, resulting in that the new conversion rates become smaller. Therefore, any new conversion rates extremely far from the average value may disappear.

It is appropriate that the conversion rate xi(j) is not set so small as to result in (xi(j)*Xi(j))<1. However, if a conversion rate for a certain partner organization should be updated at a plurality of predetermined time intervals, xi(j) is set to be so small that xi(j)*Xi(j) for one time interval is not larger than 1.

The new conversion rate for each partner organization 40 calculated by the unit 17 is stored in the conversion rate database 12, and referred to by the point management unit 16 to rewrite the amount of the member held reference points in the point database 13.

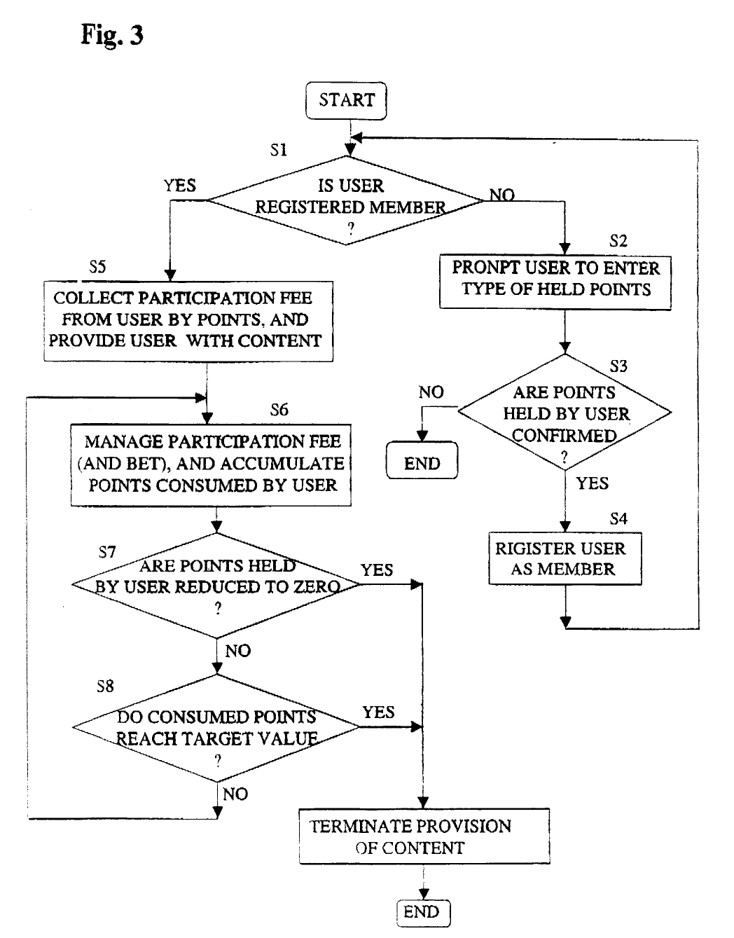

The processing performed when a user accesses the point pass-on system 10 illustrated in FIG. 1 will be described in detail with reference to a flowchart illustrated in FIG. 3.

When a user accesses the home page of the point pass-on system 10, a page is provided to the user at step S1, on which the user is asked whether the user is a registered member, and if so, is inquired to input the user ID and/or password.

If the user is not a registered member, the registration acceptance unit 14 presents a member registration page to the user at step S2 to prompt the user to enter the type(s) (or the name(s) of the partner organization(s) 40) and amount(s) of points held by the user. As the user enters for example one organization and the amount of points held by the user and associated with the organization, the point confirmation/consumption notification unit 18 confirms, to the associated organization whether the user actually holds points, and if so, how many of the points the user holds, at step S3. As the confirmation is made, a member registration process is practiced at step S4. In the member registration process, a user ID and a password are determined interactively between the registration acceptance unit 14 and the user, and the determined user ID and password are stored in the member database 11.

Then the point management unit 16 retrieves the conversion rate associated with the organization declared by the user from the database 12 to convert the amount of user held points to the amount of reference points. This data is also stored in the point database 11. If no confirmation is made at step S3, a notification is presented to the user to that affect, followed by the processing for the access made by the user.

When the user is a member and a user ID and password are entered, the process proceeds from step S1 to step S5, where the content providing unit 15 presents the user with a content selection page for selecting content, such as a game, auction, survey, contest or the like, and provides the content that is selected. The content selection page shows a participation fee for each content, which consists of the amount of reference points and the amount of points associated with the partner organizations 40, as described above. It is possible to show the point amounts only associated with the user for the declared organizations.

The point management unit 16 subtracts the participation point value and participation reference point value from the member held points and member held reference point value in the point database 13 at the time the user selects the content. Also, at step S6, the point management unit 16 manages the balance of a bet for each member if the content is a game or the like which is accompanied by a bet. In addition, the point management unit 16 adds the points consumed when the user utilizes the content, to the accumulated consumption points associated with each user and each organization in the point database 13.

After content is provided, at step S7, the point management unit 16 monitors the remaining value of the member held points in the point database 13 to determine whether or not the remaining value becomes almost zero. The unit 16 further determines at step S8 whether or not the consumed and accumulated points with respect to the provided content reach a target value. The provision of content to the user is terminated when the points held by the user are reduced to almost zero, or the consumed and accumulated points reach the target value, even if the user desires to continue the access to the content. If the determinations at both steps S7 and S8 are negative, the process returns to step S6 to provide the user with the same content.

In the case that the user holds points associated with another partner organization, when the amount of points associated with the currently selected organization becomes almost zero, the content provision unit 15 provides the user with the content selection page again to enable the user to access the same or another content with points of a different organization.

In the embodied point pass-on system described above, only registered members can enjoy the content. Alternatively, it is possible to have a system where no member registration is required. In such a case, it is necessary to previously obtain point information from all the partner organizations and store it in the point database 13, or to obtain necessary point information of a user from a partner organization 40 in response to user access to the content selection page by the user.

In addition, by making content provision historical records, it is possible to capture tendency of user preferable contents. By providing users with such preferable content, user access to the point pass-on system 10 may be accelerated, whereby the point recovery rate may be increased.

Since the present invention is configured as described above, users can enjoy contents such as a game or the like by paying a small amount of points as a participation fee, and the points accumulated as the participation fee are consumed. Thus, the points issued by partner organizations such as virtual shops, real shops or the like and remaining on the market are consumed, so that these organizations can issue new points without making a new investment for preparation of point pass-on benefits and the like.

A member, in turn, can enjoy a game content only by paying a bet with points, and can acquire a large amount of points when he or she wins the game. In this way, the user is more likely to acquire the amount of points needed to be exchanged for a service benefit or the like.

What is claimed is:

1. A point pass-on system running in computer software for restoring points issued by a plurality of partner organizations, the system comprising:
means for calculating a conversion rate for converting points issued by each of the partner organizations to a reference point value;
means for storing the conversion rates corresponding to the respective partner organizations;
means for communicating with the partner organizations and obtaining the amount of points issued thereby and held by users;
point management means for converting the amount of points issued by each partner organization and held by each user who wishes to access a content, to the amount of reference points with reference to the conversion rate associated with the partner organization;
means for storing the converted reference point amount corresponding to each user and each organization;
means for collecting a participation fee from the user held points;
means for providing the user with content; and
means for reporting to each partner organization the amount of accumulated consumption points associated therewith at a predetermined time interval, the amount of the accumulated consumption points being stored in the point storing means,
the point management means further accumulating the points for each partner organization, corresponding to the collected participation fees and storing the amount of the accumulated points as the amount of the accumulated consumption points in the point storing means.

2. A system according to claim 1, wherein
the content providing means is adapted to provide content including game content in which a user can participate only when the user pays a bet with points, and
the point management means is further adapted to accumulate the bets as consumption points for the associated organizations when no winner is determined upon completion of the game in addition to the accumulated amount of consumption points of the participation fees collected from the users.

3. A system according to claim 1, wherein when x1(j), x2(j), . . . ,xi(j), . . . ,xn(j) denote current conversion rates for the respective organizations during the current time period T(j), x1(j+1), x2(j+2), . . . ,xi(j+1), . . . ,xn(j+1) denote new conversion rates for the respective organizations during the next time period T(j+1), and X1(j), X2(j), . . . , Xi(j), . . . , Xn(j) denote recovered points for the respective organizations during the current time period T(j), the conversion rate calculating means calculates the new conversion rates on the basis of the following equation, in a case xi(j)*Xi(j)>1:
xi(j+1)=log m(xi(j)*Xi(j))/Σ log m(xk(j)*Xk(j))

4. A system according to claim 3 wherein the conversion rate calculating means is further adapted to change the base m of the logarithmic function to a larger value when at least one of the calculated new conversion rates is predetermined times as large as an average value thereof, and then repeat the above equation.

5. A system according to claim 1, wherein the content providing means further comprises means for providing a content selection page on which a user can select content, the page containing a predetermined reference point value corresponding to the participation fee for each content, and further containing point values issued by the partner organizations and corresponding to the reference point value for each content.

6. A system according to claim 1, further comprising means for registering users as members, and wherein the content providing means is adapted to provide only the members with the contents.
